(19) United States
(12) Patent Application Publication
(10) Pub. No.: US 2013/0063695 A1
(43) Pub. Date: Mar. 14, 2013

(54) THREE-DIMENSIONAL GLASSES

(71) Applicant: HUNG-YEN HSIEH, Tu-Cheng (TW)

(72) Inventor: HUNG-YEN HSIEH, Tu-Cheng (TW)

(73) Assignee: HON HAI PRECISION INDUSTRY CO., LTD., Tu-Cheng (TW)

(21) Appl. No.: 13/457,548

(22) Filed: Apr. 27, 2012

(30) Foreign Application Priority Data
Sep. 14, 2011 (TW) 100132943

(51) Int. Cl. G02C 5/16

(52) U.S. Cl. 351/113

(57) ABSTRACT

A pair of glasses comprising a glasses frame, two axles, two springs, and a pair of temples pivotally mounted on the glasses frame. The two axles and the two springs are respectively located in two separated connections between the pair of temple arms and the glasses frame.

### TECHNICAL FIELD

The disclosure relates to glasses, and more particularly to a pair of three-dimensional glasses having an adjusting device in temple arms.

### DESCRIPTION OF THE RELATED ART

As three-dimensional (3D) videos become popular, 3D glasses for watching these 3D videos are more in demand. The visual 3D effect of a pair of 3D glasses is principally made by the visual parallax effect via a pair of optical lenses, whereby users can place the 3D glasses on their faces to watch 3D videos through the optical lenses. However, regular sizes of 3D glasses generally may just include two types, for adults and children, thereby maximum intervals between a pair of temple arms of these two type 3D glasses are constant, but that may not be proper for every user due to different sizes or shapes of faces. Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic diagram of a pair of glasses of the disclosure.

FIG. 2 is an exploded diagram of an articulate portion of a glasses frame and a joint extreme of a temple arm of the glasses in accordance with FIG. 1.

FIG. 3A is an exploded diagram of a shelter and a pivot seat of the articulate portion in accordance with FIG. 2.

FIG. 3B is a schematic diagram of the shelter and the pivot seat of the articulate portion in accordance with FIG. 2.

FIG. 4 is a cross section of the articulate portion of the glasses frame and the joint extreme of the temple arm in accordance with FIG. 2.

FIG. 5 is a schematic diagram showing the glasses in a ready to use state.

### DETAILED DESCRIPTION

Exemplary embodiments of the disclosure will be described with reference to the accompanying drawings.

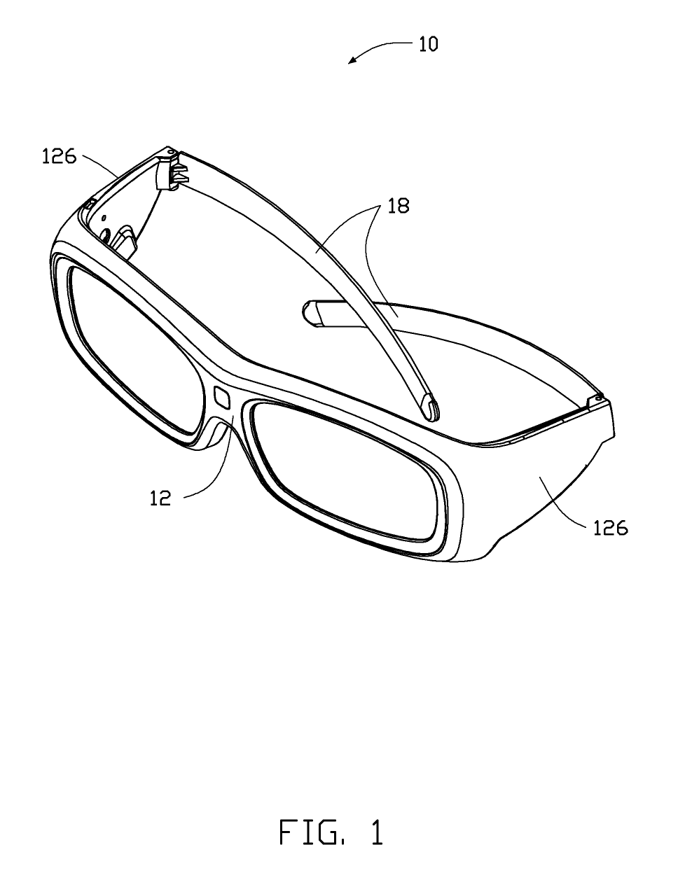

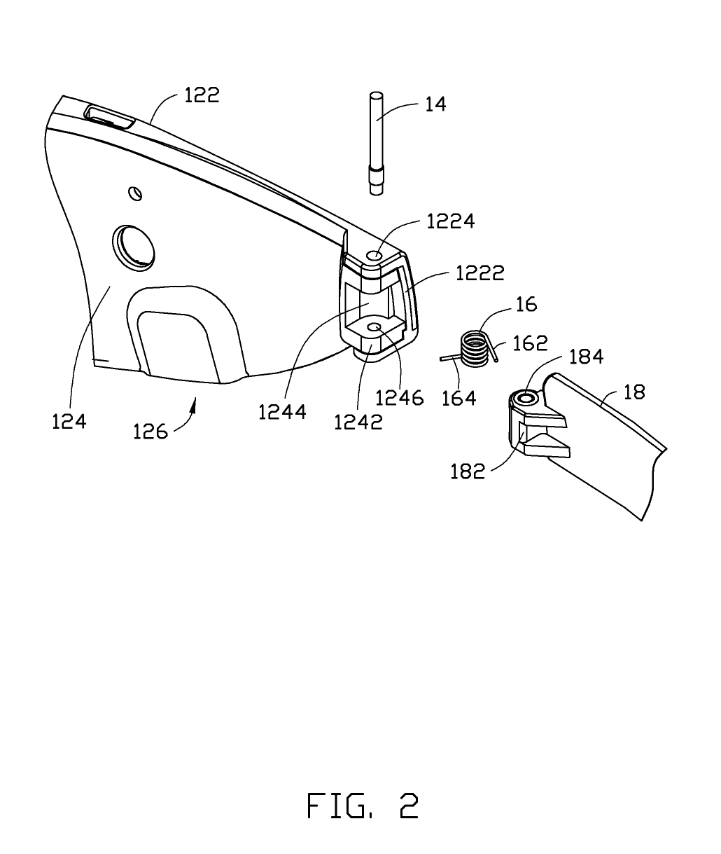

Referring to FIG. 1 and FIG. 2, the disclosure provides a pair of glasses 10 comprising a glasses frame 12, two axles 14, two springs 16, and a pair of temple arms 18. The pair of temple arms 18 is pivotally mounted on two ends of the glasses frame 12. The two axles 14, and the two springs 16, are respectively located in two separated connections between the pair of temple arms 18 and the glasses frame 12.

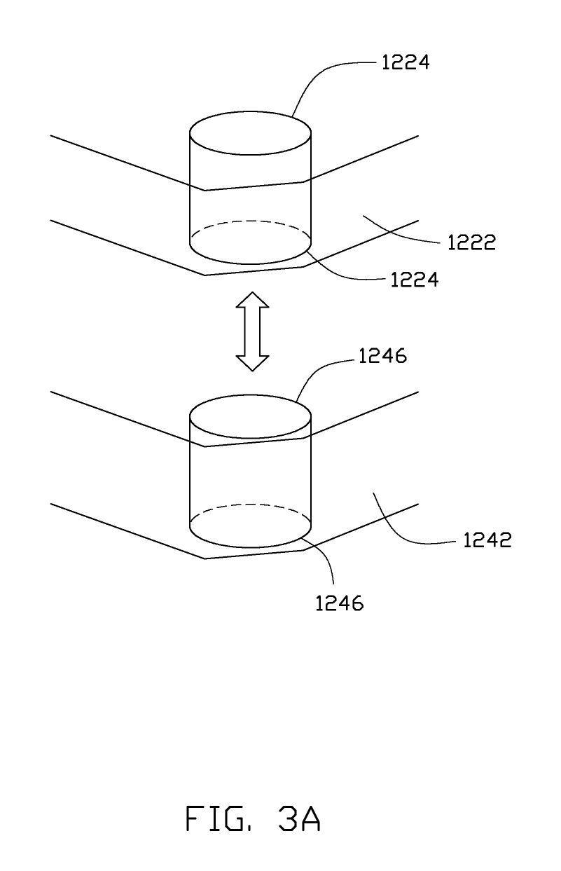

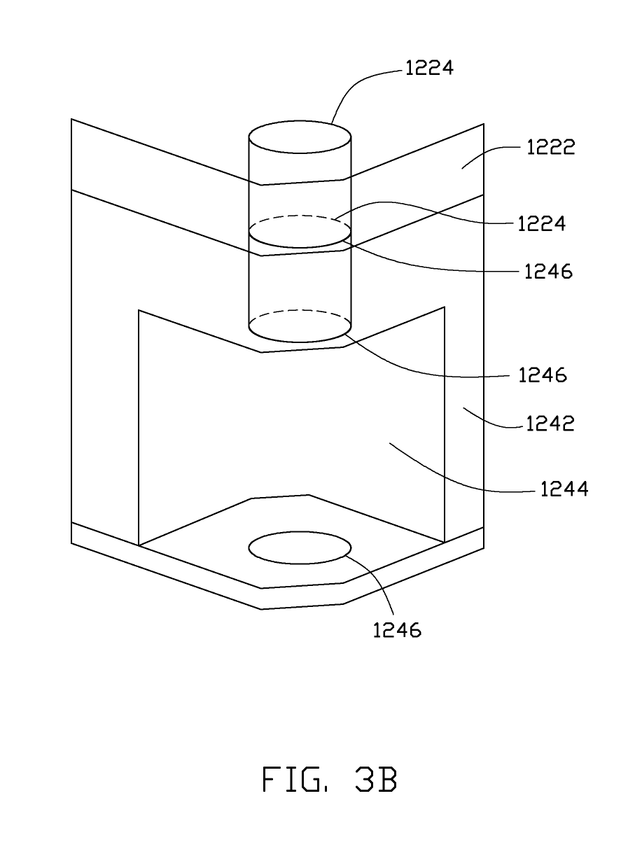

The glasses frame 12 comprises a front frame 122 and a rear frame 124. As the pair of glasses 10 is being used, the rear frame 124 faces to a user who wears the pair of glasses 10 placed on his/her face. Moreover, a pair of optical lenses (not shown) is fixed between the front frame 122 and the rear frame 124. Alternatively, the pair of optical lenses can be composed of a blue and a red color filter, a pair of polarized lenses, a pair of 3D display lenses or a pair of 3D liquid crystal glasses to produce the visual parallax effect. The glasses frame 12 further comprises a U-shaped articulate portion 126 extending from two opposite ends of the glasses frame 12. The pair of temple arms 18 is pivotally mounted on the articulate portion 126 by the two axles 14 to be able to fold inwards or unfold outwards. The rear frame 124 comprises a pivot seat 1242 having a carrier space 1244 and two first apertures 1246 respectively passing through a top surface and a rear surface of the pivot seat 1242 from the carrier space 1244 to the exterior. The front frame 122 comprises a shelter 1222 covering the top surface, the rear surface and a lateral side of the pivot seat 1242, and two second apertures 1224 respectively pass through a top surface and a rear surface of the shelter 1222 from the pivot seat 1242 to the exterior. As shown in FIG. 3A and FIG. 3B, The two first apertures 1246 separately correspond to and connect with the two second apertures 1224. In the embodiment, the first top aperture 1246 connects to the second top aperture 1224, and the first rear aperture 1246 connects to the second rear aperture 1224, wherein the top apertures 1224 and the rear apertures 1246 are isolated by the carrier space 1244.

Each of the pair of temple arms 18 comprises a joint extreme 182 located on one end of the temple arms 18 to engage with the articulate portion 126 of the glasses frame 12. More specifically, when the joint extreme 182 of the temple arm 18 is inserted into the carrier space 1244 of the pivot seat 1242, the longitudinal axis of the axle bore 184 is collinear with the longitudinal axis of the first aperture 1246 and also collinear with the longitudinal axis of the second aperture 1224, that is, all three axis are on the same straight line. The axle 14 is inserted through the first aperture 1246, through the axle bore 184 and through the second aperture 1224.

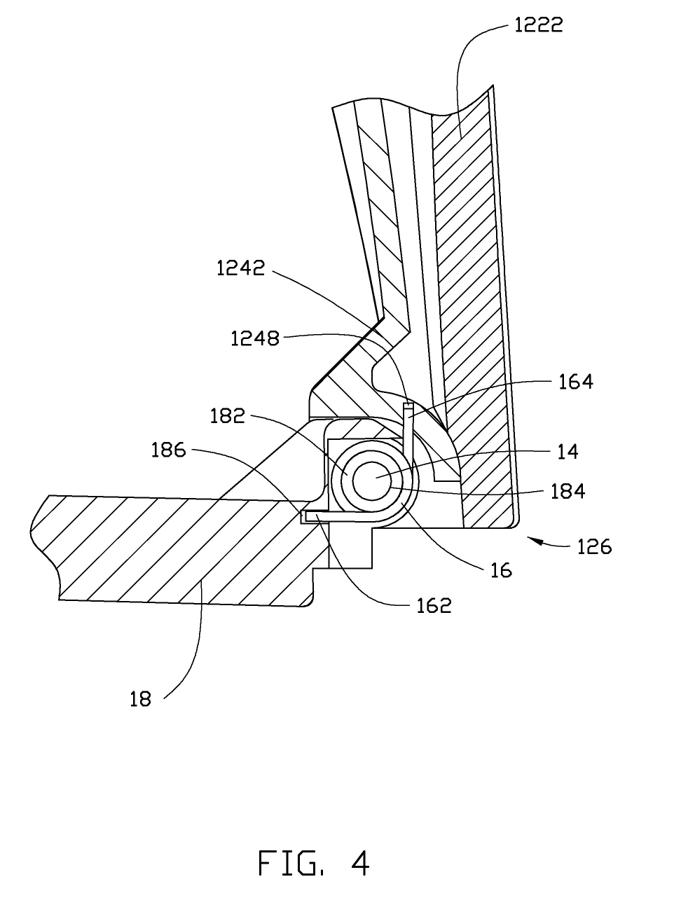

Referring to FIG. 2 and FIG. 4, each of the springs 16 hooks the joint extreme 182 of the temple arm 18. The spring 16 comprises an upper end portion 162 and a lower end portion 164. The upper end portion 162 is inserted into a first groove 186 of the temple arm 18, and the lower end portion n 164 is inserted into a second groove 1248 of the pivot seat 1242, such that the spring 16 can be tightly fixed between the temple arm 18 and the articulate portion 126 of the glasses frame 12.

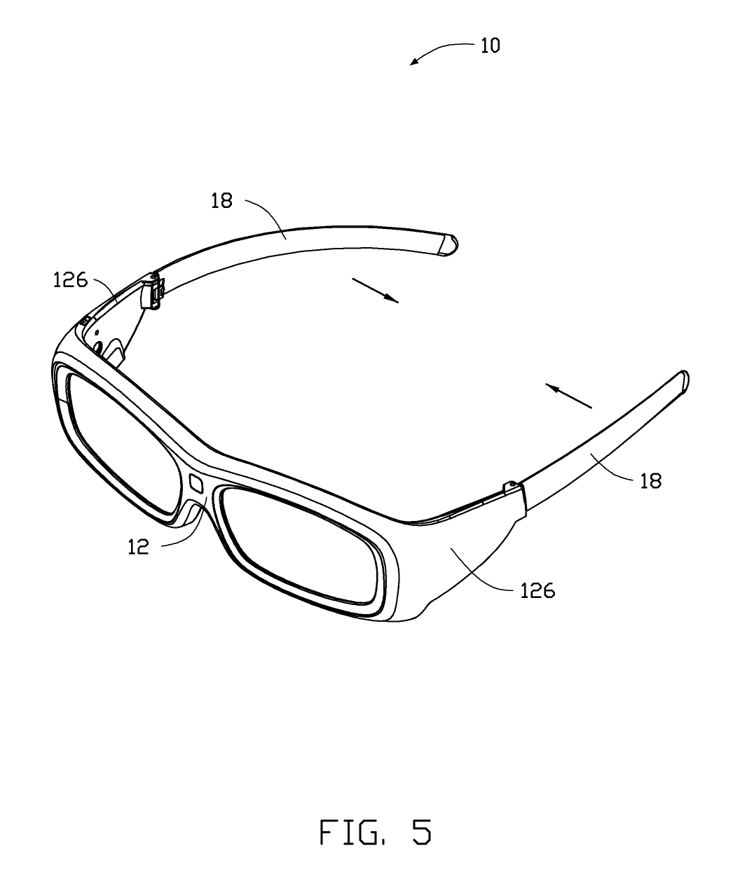

When the pair of glasses 10 is not in use, as shown in FIG. 1, the springs 16 force the pair of temple arms 18 to pivot inward in the vicinity of the optical lens between the two articulate portions 126. Otherwise, when the pair of glasses 10 is used, or is place on the face of a user, the pair of temple arms 18 is pivoted outward until an interval between the pair of temple arms 18 allows the user to slip his/her head through the interval and wear the pair of glasses 10 on his/her face. Moreover, as shown in FIG. 5, the pair of temple arms 18 clamps on both sides of the user's head by a spring force from the two springs 16, so the pair of glasses 10 is tightly fixed on the face of the user.

Accordingly, the pair of glasses 10 is adapted for any user with different sizes or shapes of faces whether the user is a child or an adult. Moreover, the pair of glasses 10 has simple structure and is convenient to use.

It is to be understood, however, that even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A pair of glasses, comprising:
a glasses frame, having an articulate portion extending from two ends of the glasses frame;
a pair of temple arms, pivotally mounted on the two ends of the glasses frame, each of the pair of temple arms comprising a joint extreme pivotally mounted on the articulate portion by an axle; and
two spring, separately hooked on the joint extremes of the pair of the temple arms, each of the two springs comprises an upper end portion and a lower end portion respectively inserted into the joint extreme and the articulate portion.

2. The pair of glasses as claimed in claim 1, wherein the glasses frame is composed of a front frame and a rear frame.

3. The pair of glasses as claimed in claim 2, wherein a pair of optical lenses is fixed between the front frame and the rear frame.

4. The pair of glasses as claimed in claim 3, wherein the pair of optical lenses is composed of a blue and a red color filters, a pair of polarized lenses, a pair of 3D display lenses or a pair of 3D liquid crystal glasses.

5. The pair of glasses as claimed in claim 2, wherein the rear frame comprises a pivot seat having a carrier space and two first apertures respectively passing through a top surface and a rear surface of the pivot seat from the carrier space to exterior.

6. The pair of glasses as claimed in claim 5, wherein the front frame comprises a shelter covering a top surface, a rear surface, a lateral side of the pivot seat, and two second apertures respectively passing through a top surface and a rear surface of the shelter from the pivot seat to external.

7. The pair of glasses as claimed in claim 6, wherein the two first apertures separately correspond to the two second apertures.

8. The pair of glasses as claimed in claim 7, wherein the joint extreme comprises an axle bore hooked by the spring.

9. The pair of glasses as claimed in claim 8, wherein the axle inserted through the axle bore and the pivot seat from one of the second apertures to another.

10. The pair of glasses as claimed in claim 1, wherein the joint extreme comprises a first groove, and the upper end portion of the spring is inserted into the groove of the joint extreme.

11. The pair of glasses as claimed in claim 10, wherein the articulate portion comprises a second groove, and the lower end portion of the spring inserts into the second groove of the articulate portion.

12. A pair of glasses, comprising:
a glasses frame, having an articulate portion extending from two ends of the glasses frame;
a pair of temple arms, pivotally mounted on the two ends of the glasses frame, each of the pair of temple arms comprising a joint extreme pivotally mounted on the articulate portion of the glasses frame;
two spring, separately hooked on the joint extremes of the pair of temple arms, each of the two springs comprises an upper end portion adjacent to the joint extreme and a lower end portion adjacent to the articulate portion; and
two axles, each of them inserting through the temple arm and the articulate portion to fix the pair of temple arms on the articulate portion.

13. The pair of glasses as claimed in claim 12, wherein the glasses frame is composed of a front frame and a rear frame.

14. The pair of glasses as claimed in claim 13, wherein a pair of optical lenses is fixed between the front frame and the rear frame.

15. The pair of glasses as claimed in claim 14, wherein the pair of optical lenses is composed of a blue and a red color filters, a pair of polarized lenses, a pair of 3D display lenses or a pair of 3D liquid crystal glasses.

16. The pair of glasses as claimed in claim 13, wherein the rear frame comprises a pivot seat having a carrier space and two first apertures respectively passing through a top surface and a rear surface of the pivot seat from the carrier space to exterior.

17. The pair of glasses as claimed in claim 16, wherein the front frame comprises a shelter covering a top surface, a rear surface, a lateral side of the pivot seat, and two second apertures respectively passing through a top surface and a rear surface of the shelter from the pivot seat to exterior.

18. The pair of glasses as claimed in claim 17, wherein the two first apertures separately correspond to the two second apertures.

19. The pair of glasses as claimed in claim 18, wherein the joint extreme comprises an axle bore hooked by the spring, and the axle inserting through the axle bore and the pivot seat from one of the second apertures to another.

20. The pair of glasses as claimed in claim 12, wherein the joint extreme comprises a first groove, and the upper portion of the spring is inserted into the groove of the joint extreme, and the articulate portion comprises a second groove, and the rear portion of the spring inserts into the second groove of the articulate portion.
